(19) United States
(12) Patent Application Publication
(10) Pub. No.: US 2004/0162699 A1
(43) Pub. Date: Aug. 19, 2004

(54) Method and device for detecting an object point on an object

(76) Inventor: Wolfgang Buss, Pohlheim (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/479,508

(22) PCT Filed: Jun. 21, 2002
(86) PCT No.: PCT/EP02/06898

(30) Foreign Application Priority Data
Jun. 21, 2001 (DE) 101 29 496.4
Aug. 21, 2001 (DE) 101 39 945.6

(51) Int. Cl. G01C 9/00

(52) U.S. Cl. 702/150

(57) ABSTRACT

The invention relates to a method and a device for detecting an object point (12) on an object (14) such as a work piece or a tool, by means of a sensor (16). In order to obtain an extremely precise measurement at a high measuring speed, a first detection of the object point (12) is carried out by displacing the sensor (16) in the direction of the object (14) at a first speed V₁ and a second detection of the object point (12) is carried out by moving the sensor (16) away from the object (14) at a second speed V₂, the actual measured value being determined by the second object point detection.

The invention relates to a method and device for detecting an object point on an object such as a work piece or tool by means of a sensor.

From the state of the art are known methods and devices in which a sensor is configured as a switching and measuring probe. The nature of the known method consists in scanning an object point such as a work piece surface by moving the mechanical probe and reading the assigned position measuring systems when the probe makes contact for the first time with the object point. The coordinates of the sensor during scanning are extracted from the position measuring system and made available for further processing.

The disadvantage of the aforementioned method is that the sensor is very sensitive to disturbances during scanning. Vibrations and the like can lead to erroneous triggering. To prevent this, it is suggested in WO 88/01726 to switch a probe to the non-sensitive mode during fast positioning motions and to switch to a slower motion with a higher level of sensitivity shortly before scanning the target point.

This, however, leads to the disadvantage that, on the one hand, the actual scanning process must be performed at a very low speed, which leads to a loss in time and, on the other hand, the system remains susceptible to disturbances during the actual scanning process. A secure measurement, in particular under rough surrounding conditions, is therefore not possible.

Based on this, it is the object of the invention to further develop a method as well as a device of the above-mentioned kind so that an extremely precise measurement can be performed at a high measuring speed.

The object is attained with a method of the above-mentioned kind essentially by carrying out a first detection of an object point by moving the sensor in the direction of the object at a first speed V₁ and carrying out a second detection of the object by displacing the sensor away from the object at a second speed V₂, whereas the actual measured value determination is carried out during the second detection of the object.

A preferred procedure is characterized in that the first detection of the object point is carried out as a rough object point detection at a high speed V₁ and the second detection of the object point is carried out as an accurate object point detection at a low speed V₂.

The method pursuant to the invention prevents the disadvantages experienced with the prior art in that the object is scanned with relative imprecision at the first high scanning speed V₁ and thus a high level of measuring speed is achieved. The measured value determined in this way is only used to record the approximate object point. The actual measured value is taken when displacing the sensor away from the object, that is, when moving the sensor away from the object.

To ensure a precise measurement, a low speed V₂ is selected when moving away to meet the scanning accuracy requirements. This speed, however, must be adjusted around the actual object point only for a short displacement section. The overall advantage is a higher measuring speed together with a simultaneous greater precision, wherein in particular the scanning errors known from the state of the art are avoided.

The first high speed V₁ is preferably within the range of 5 mm/s≦V₁≦10 m/s, preferably V₁≈1 m/s, and the second low speed V₂ in the range of 0.1 mm/s<V₂<200 mm/s, preferably V₂≈0.5 mm/s. To this end, it is provided that the second speed V₂ is adjusted to a constant value during the second object detection. After detecting the object point during the displacement in the direction toward the object, the sensor is stopped after a time T₁ within the range of 0.1 ms≦T₁≦1, preferably 10 ms.

To prevent the problem of an erroneous scanning with sensitive sensors as a result of vibrations and a bouncing behavior, the sensor is moved in a direction away from the object at the low speed V₂ after a bouncing cycle has subsided and a trigger signal is set when moving the sensor away from the object, with which a filter used for the filtration of the measured signal is switched off, whereupon the position of the object point is stored when the measured value drops below a specified value, the trigger signal is reset, and the filter is switched on again.

In other words, the actual measured value detection from the second object point detection occurs at a speed V₂ that is directed away from the object. For certain sensors such as autofocus sensors, the final measured value can also be determined by mathematically linking the measured values of both object point detection operations.

To realize a digital measured value processing, a measured signal that is available in analog form is digitized and finally digitally processed.

Mechanically switching and/or measuring scanners are used as sensors in a preferred embodiment. In order to prevent a bouncing of the measured signal during the scanning of the object point, the sensor is dampened with auxiliary mechanical devices, whereupon the dampening is disabled during the second object point detection.

Apart from the mechanically switching and/or measuring probes are also provided optical and/or optoelectronic sensors.

The invention relates moreover to a device for detecting an object point on an object, such as a work piece or tool, comprising at least one displaceable sensor that is connected to an evaluating unit.

With regards to this device, the invention is essentially characterized in that for the first detection of the object point the sensor can be displaced in the direction of the object at a first speed V₁ and that for the second detection of the object point the sensor can be displaced in the direction away from the object, while the evaluating unit has means for evaluating a measured signal existing on the sensor during the second detection of the object point.

With this device is avoided the problem of erroneous scanning with sensitive probes/sensors as a consequence of vibrations and a bouncing behavior by way of the second detection of the object point while moving away from the object. A preferred embodiment is characterized in that the speed of the sensor can be adjusted, preferably controlled, wherein the sensor can be displaced at a high speed V₁ in the direction toward the object during the first detection of the object point, and can be displaced at a low speed V₂ in the direction away from the object during the second detection of the object point.

In a preferred embodiment, the evaluating unit has an amplifier unit, at least one filter unit, at least one converter unit, as well as a computer.

In order to be able to undertake an adaptation of the measured signal supplied by the sensor, the amplifier unit that is connected to the output of the sensor is configured as a programmable amplifier. It is also provided, moreover, that an output of the amplifier unit is connected to the input of the filter unit. The filter unit preferably consists of two programmable filters, such as for example a lowpass filter and/or a bandpass filter. The programmable filters can be selectively switched on and off.

It is further provided that an output of the filter unit is connected to a converter unit, preferably a programmable precision analog-to-digital converter, whose output is connected to the computer, which can be a microcomputer. The output of the filter unit is also connected to the input of a rectifier unit, whose output is connected to an input of a preferably programmable comparator, whose output is connected to the input of the computer.

The programmable filter unit has the advantage that the lowpass filter can be optionally switched on and off, whereas the lowpass filter is only turned on during a general positioning procedure and the respective first object point detection. In a preferred embodiment, it is provided that the switchable lowpass filter is configured as a software component. As an alternative, the switchable lowpass filter can also be configured as a hardware component.

Pursuant to a particularly preferred embodiment, it is provided that the evaluating unit has a sensor detector that provides the possibility that the evaluating unit will autonomously recognize the type of sensor that is connected. In particular both measuring and switching sensors can be coupled.

As a particular advantage of the device it should be mentioned that various sensors can be used. For example, the sensor can be configured as a mechanically switching or measuring probe. The sensor can also be configured as a laser distance sensor. As an alternative, it is possible for the sensor to be an autofocus sensor. Also optical and optoelectronic sensors can be used.

Another advantage that should be mentioned is that the device is suitable for holding several sensors. The device itself can be designed as a coordinate measuring device or as a machine tool. To further improve the scanning behavior, the sensor can be configured as a single-speed or multi-speed switchable scanning system.

Further details, advantages and features of the invention result not only from the claims and the features disclosed therein (either alone and/or in combination), but also from the following description of preferred exemplary embodiments shown in the drawings, wherein:

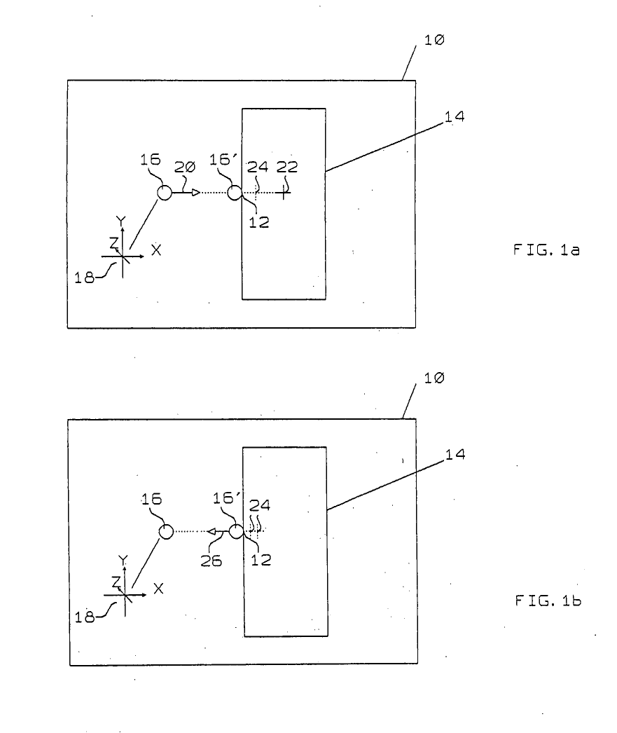

FIG. 1a shows a schematic depiction of the sensor during the displacement of the sensor in the direction toward the object,

FIG. 1b shows a schematic depiction of the sensor during the displacement of the sensor in the direction away from the object,

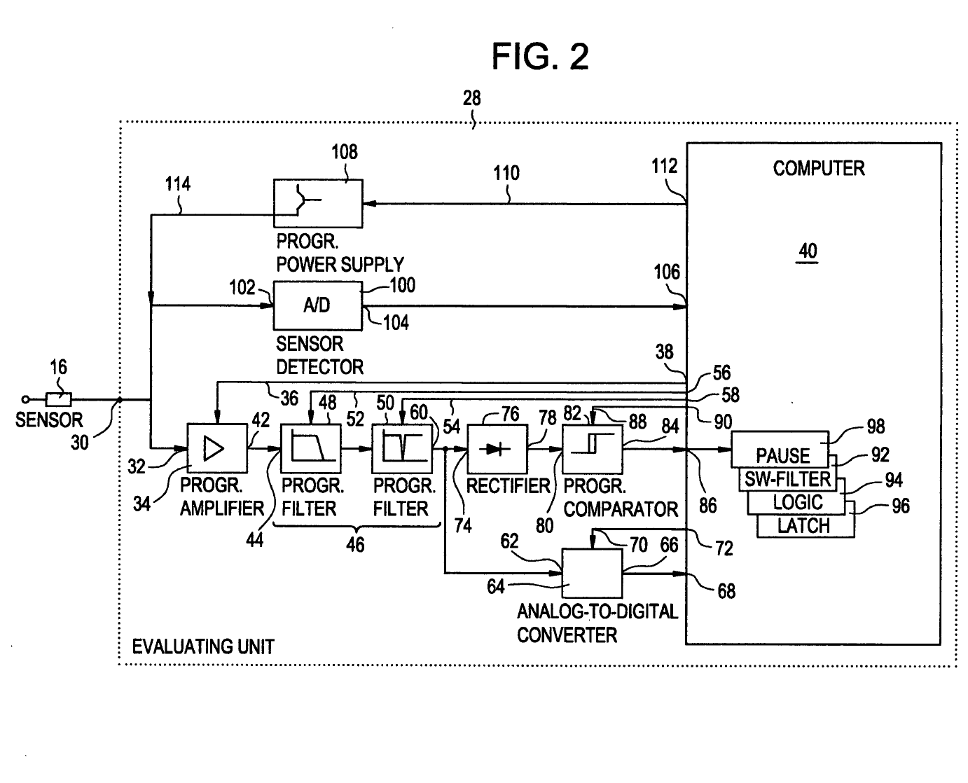

FIG. 2 shows a block diagram of an evaluating unit,

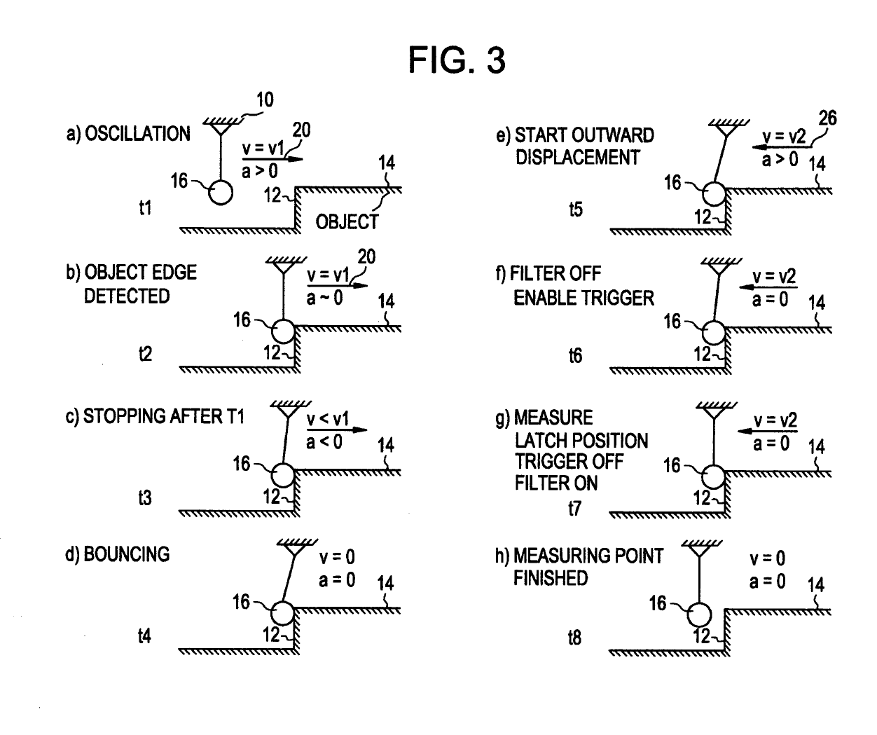

FIG. 3a)-h) show positions of the sensor relative to the object in various displacement situations, and

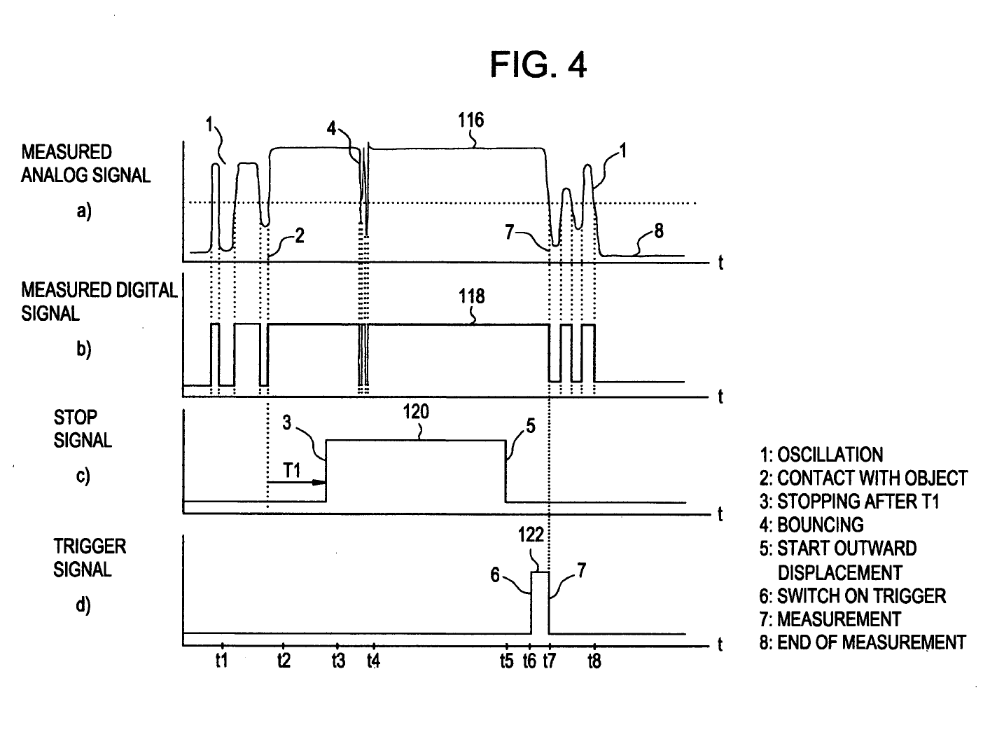

FIG. 4a)-d) show different measured signals and control signals.

FIGS. 1 and 2 show purely schematically a device 10 for detecting an object point 12 on an object 14, such as a work piece or a tool. The device 10 comprises at least one sensor 16, which can be displaced by means of a positioning system in the X, Y and Z directions of a Cartesian coordinate system 18.

FIG. 1a) shows the sensor 16 in its starting position, from which the sensor can be displaced at a speed V=V₁ in the direction of the arrow 20, that is, in the direction toward the object 14, in particular in the direction of a defined scanning target point 22. As soon as the sensor 16′ has detected the object point during a first detection of the object point, the positioning system stops at a stop point 24, which is located on a line between the object point 12 and the scanning target point 22. The object point 12 is detected only roughly during the first object point detection.

FIG. 1b) shows a process step, in which the sensor 16′ is moved away from the object at a low speed V₂ in the direction of the arrow 26. At the same time is carried out a second accurate detection of the object point, from which the actual measured value is determined.

FIG. 2 shows an evaluating unit 28 that is connected to the sensor 16. An output 30 of the sensor is connected to an input 32 of an amplifier unit 34 and is configured as a programmable amplifier unit in the exemplary embodiment. For programming purposes, the amplifier 34 is connected via a connection 36 to an output 38 of a computer 40 such as a microcomputer.

An output 42 of the amplifier 34 is connected to the input 44 of a filter unit 46, which in the example that is depicted comprises a programmable, in particular a switchable lowpass filter 48 as well as a preferably programmable bandpass filter 50, which are respectively connected via connections 52, 54 to outputs 56, 58 of the microcomputer 40. At least one of the filter units 48, 50 is preferably configured to be switchable.

An output 60 of the filter unit 46 is connected to an input 62 of a precision analog-to-digital converter 64, whose output 66 is connected to an input 68 of the microcomputer 40. The analog-to-digital converter 64 is also configured to be programmable and is connected via a connection 70 to an output 72 of the microcomputer 40. The output 60 of the filter unit 46 is moreover connected to the input 74 of a rectifier 76, whose output 78 is connected to an input 80 of a programmable comparator 82. An output 84 of the comparator is connected to an input 86 of the microcomputer 40. To program the comparator, the latter is connected via a connection 88 to an output 90 of the microcomputer 40.

The filter unit 46 as well as the analog-to-digital converter 64 can optionally be configured as software components or hardware components. The microcomputer 40 is also provided with software filters 92, logic components 94, as well as memory units 96 and timers 98.

For the detection of various sensors 16 is provided a sensor detector 100, whose input 102 is connected to the output 30 of the sensor and whose output 104 is connected to an input 106 of the microcomputer 40.

For power supply purposes, the evaluating unit 28 comprises a programmable power supply unit 108, which is connected via a connection 110 to an output 112 of the microcomputer 40 and whose output 114 makes available the power supply for the sensor 16, the sensor detector 100, as well as for signal processing.

The sensor 16 can be configured as a mechanically switching and/or measuring probe. Optical or optoelectronic sensors can also be used, for example, in the form of a laser distance sensor or an autofocus sensor. It is also possible to use as sensor a single-speed or multi-speed switching scanning system.

The method pursuant to the invention avoids the problem of an erroneous scanning with sensitive sensors as a consequence of vibrations and bouncing by way of an object point detection while moving away from the object.

The method will now be explained in greater detail with reference to FIGS. 3a)-h) as well as FIGS. 4a)-d). FIGS. 3a)-h) show the sensor 16 in various positions relative to the object 14. FIG. 4a shows an analog measured signal 116 of the sensor 16 and FIG. 4b) shows a digitized measured signal 118, which was derived by digitization from the analog measured signal 116. FIG. 4c) reveals a signal 120 for the selection of the positioning system 18, and FIG. 4d) depicts a trigger signal 122 for controlling the measured value recording unit when moving the sensor 16 away.

At the time t₁ pursuant to FIG. 3a), the sensor 16 is in a starting position and is displaced starting from said position at a first speed V-V₁ in the direction of the arrow 20 at an acceleration of a>0. During the acceleration process can occur vibrations of the sensor 16, which are visible in the measured signals 116, 118 pursuant to FIGS. 4a) and 4b) (area 1).

At a time t₂, the sensor 16 reaches the object 14 and detects the object point 12 or an edge of the object. The first object point detection takes place at a relatively high speed V₁, that is, with a low accuracy. The corresponding rough measured value of the first object detection can be stored for further processing.

After the sensor 16 has detected the object point 12, the positioning system 18 is moved further at an essentially constant speed V=V₁ in the direction of the arrow 20 towards the stop point 24 and (as shown in FIG. 4c) is stopped after a time t₀ at the time t₃. For this purpose, the stop signal 120 shown in FIG. 4c is set from the LOW state into the HIGH state (edge 3).

The scanning of the sensor 16 on the object point 12 can lead to a bouncing cycle, which is depicted at the time t₄ in the measured signal curves 116, 118 as a high-frequency oscillation (area 4). At this time, the positioning system has the speed V=0 and the acceleration A=0.

After the bouncing cycle has concluded, the stop signal 120 shown in FIG. 4c is reset (edge 5) so that the sensor 16 is moved to the second object point detection at a low speed V=V₂ in the direction of the arrow 26 away from the object 14, that is, it is moved away.

When the sensor 16 is moved away, pursuant to the invention, the second object point detection occurs at the low speed V₂ and thus with accordingly greater precision. The trigger signal 122 is set at a time t₆, that is, it is switched from a LOW level to a HIGH level and the filter 48, 50 is switched off at the same time or essentially at the same time. The speed V₂ during the second object point detection is calculated so that the positioning system 18 is moved at a constant speed within the range of the expected measuring uncertainty of the first object point detection.

At the time t₂ (shown in FIG. 3g), the sensor 16 detaches from the object point 12, which is shown by a drop in the measured signal 116 or the digitized measured signal 118. The drop in the measured signal 116, 118 resets the trigger signal 122 at the time t₇ (area 7), so that the actual measured value can be determined with a high level of accuracy.

The filter 28 is re-activated at the time t₇. The sensor 16 can oscillate after it has left the object point 12, but this has no effect on the measuring result. The oscillation is shown in the measured signals in FIGS. 4a-b (area 1′). The measurement is completed (area 8) at the time t₈, that is, after the oscillation has subsided.

In summary, it id determined that the disadvantages of the state of the art are avoided with the method pursuant to the invention by scanning the object 12 relatively inaccurately at a high speed V₁, wherein the detected measured value is used only to roughly record the object point. The actual measured value is taken when the sensor 16 moves away from the object 14 because a speed V₂ with lower speed requirements is selected for this movement. Said speed must only be set for the short displacement section traveled between the points in time t₇ through t₅ around the actual object point. The method works in particular both for sensors 16 with switchable scanning systems (trigger probe) as well as also for sensors 16 with measuring scanning systems (scanning probe). A higher measuring speed with a simultaneous higher accuracy while avoiding scanning errors is especially achieved with the method.

1. A method for detecting an object point (12) on an object (14) such as a work piece or tool by means of a sensor (16),
wherein
a first detection of the object point (12) occurs by displacing the sensor (16) in the direction toward the object (14) at a first speed V₁, and that a second detection of the object point (12) occurs by displacing the sensor (16) away from the object (14) at a second speed V₂, whereas the actual measured value is determined during the second object point detection.

2. The method of claim 1,
wherein
the first detection of the object point (12) is carried out as a rough object point detection at a high speed V₁ and the second detection of the object point (12) is carried out as an accurate object point detection at a low speed V₂.

3. The method of claim 1 or 2,
wherein
a measured value that was determined during the first detection of the object point (12) is used to roughly determine the object point (12).

4. The method of at least one of the preceding claims,
wherein
the actual measured value during displacement of the sensor (16) away from the object (14), that is, when the sensor (16) is moved away or outwardly, is taken over from the object.

5. The method of at least one of the preceding claims,
wherein
the second low speed V₂ is set merely within a narrow range that is close to the object point.

6. The method of at least one of the preceding claims,
wherein
the first high speed V₁ is within the range of 5 mm/s<V₁≦10 m/s, preferably V₁=1 m/s, and the second low speed V₂ is within the range of 0.1 mm/s≦V₂≦200 mm/s, preferably V₂=0.5 mm/s.

7. The method of at least one of the preceding claims,
wherein
the second speed V₂ is adjusted to a constant value during the second detection of the object point (12).

8. The method of at least one of the preceding claims,
wherein
after the object point (12) has been detected during the displacement in the direction toward the object (14), the sensor (16) is stopped after a time Tₓ within the range of 0.1 ms≦T₁≦1 s, preferably 10 ms.

9. The method of at least one of the preceding claims,
wherein
the sensor (16) is moved in the direction away from the object (14) at the low speed V₂ after a bouncing cycle has subsided, and wherein a trigger signal is set when the sensor (16) is displaced or moved away from of the object or outwardly, with which a filter (46) used for filtration of the measured signal (116, 118) is switched off, whereupon the trigger signal (122) is reset, the position of the object point (12) is stored, and the filter (46) is switch on again when the measured signal (116, 118) drops below a specified value.

10. The method of at least one of the preceding claims,
wherein
the final measured value for certain sensors is determined by mathematically linking the measured values of the two object point detection procedures.

11. The method of at least one of the preceding claims,
wherein
a measured signal (116) that is available in analog form is digitized and subsequently further processed digitally.

12. The method of at least one of the preceding claims,
wherein
mechanically switching and/or measuring probes are used as sensors (16).

13. The method of at least one of the preceding claims,
wherein
the sensor (16) is dampened with auxiliary mechanical devices, whereupon the dampening is disabled during the second object point detection.

14. The method of at least one of the preceding claims,
wherein
optical and/or optoelectronic sensors are used as sensors (16).

15. A device (10) for detecting an object point (12) on an object (14) such as a work piece or tool, comprising at least one displaceable sensor (16) connected to an evaluating unit (28),
wherein
the sensor (16) can be displaced at a first speed V, for a first detection of the object point (12) in the direction of the object point (12), and the sensor (16) can be displaced away from the object for the second detection of the object point (12), while the evaluating unit (28) comprises devices (34, 46, 64, 76, 82, 40) for evaluating a measured signal (116) that exists on the sensor (16) during the second detection of the object point (12).

16. The device of claim 15,
wherein
the speeds V₁ and V₂ of the sensor are adjustable, preferably controllable, while the sensor (16) can be displaced at a high speed V₁ in the direction of the object (12) during the first detection of the object point (12), and can be displaced at a low speed V₂ in the direction away from the object (12) during the second detection of the object point (12).

17. The device of claims 15 and 16,
wherein
the evaluating unit (28) comprises an amplifier unit (34), at least one filter unit (46), at least one converter unit (64, 76, 82), as well as a computer (40), which can be a microcomputer.

18. The device of claims 15 through 17,
wherein
an output (30) of the sensor (16) is connected to an input (32) of the amplifier unit (34) configured as a programmable amplifier, and an output (42) of the amplifier unit (34) is connected to an input (44) of the filter unit (46), and wherein an output (60) of the filter unit (46) is connected, on the one hand, to an input (62) of an analog-to-digital converter (64), whose the output (66) is connected to an input (68) of the computer (40) and is connected, on the other hand, to an input (74) of a rectifier (76), whose output (78) is connected to an input (80) of a comparator (82), which is connected with its output (84) to an input (86) of the computer (40).

19. The device of claims 15 through 18,
wherein
the amplifier unit (34) is connected to the computer and can be programmed via a connection (36).

20. The device of claims 15 through 19,
wherein
the filter unit (46) comprises a programmable lowpass filter (48) and/or a programmable bandpass filter (50), while the filter is connected to an output (56, 58) of the computer (40) via a connection (52, 54), respectively, and can selectively be switched on and off.

21. The device of claims 15 through 20,
wherein
the analog-to-digital converter (64) is connected and can be programmed via a connection (70) to an output (72) of the computer (40).

22. The device of claims 15 through 21,
wherein
the comparator (82) is connected and can be programmed via a connection (88) to an output (90) of the computer (40).

23. The device of claims 15 through 22,
wherein
the evaluating unit (28) has a sensor detector (100) provided with the possibility that the evaluating unit (28) autonomously detects the type of sensor that is connected.

24. The device of claims 15 through 23,
wherein
the sensor (16) is configured as a measuring and/or as a switching probe.

25. The device of claims 15 through 24,
wherein
the sensor (16) is configured as a mechanically switching and/or measuring probe.

26. The device of claims 15 through 25,
wherein
the sensor (16) is configured as a laser distance sensor.

27. The device of claims 15 through 26,
wherein
the sensor (16) is designed as an autofocus sensor.

28. The device of claims 15 through 27,
wherein
the sensor (16) is configured as an optical and/or optoelectronic sensor.

29. The device of claims 15 through 28,
wherein
the device (10) is configured to hold several sensors (16).

30. The device of claims 15 through 29,
wherein
the device (10) is a coordinate measuring device.

31. The device of claims 15 through 30,
wherein
the device (10) is a machine tool.

32. The device of claims 15 through 31,
wherein
the sensor (16) is a single-speed or multi-speed switching scanning system.
